(19) United States
(12) Patent Application Publication
(10) Pub. No.: US 2008/0077546 A1
(43) Pub. Date: Mar. 27, 2008

(54) Evaluation Method and Evaluation Device for a System of Seat Occupancy Detection

(75) Inventors: Klaus Hofbeck, Neumarkt (DE); Birgit Rosel, Regensburg (DE); Arnd Stielow, Regensburg (DE); Roland Wagner, Donaustauf (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/631,775

(22) PCT Filed: Jul. 5, 2005
(86) PCT No.: PCT/EP05/53187

§ 371 Date: Jan. 5, 2007

(30) Foreign Application Priority Data
Jul. 5, 2004 (DE) 10 2004 032 473.5

(51) Int. Cl. B60R 21/02; G06N 5/00

(52) U.S. Cl. 706/46

(57) ABSTRACT

A method and device for evaluating a number of reflector responses of a system for detecting the occupancy of a seat. Decision values are determined from reflector responses of different areas of a seat according to determination rules assigned to the individual areas. The decision values are classified according to a threshold value rule in order to determine an evaluation result.

The invention relates to a method for evaluating a number of reflector responses of a system for seat occupancy detection and a corresponding device.

Systems for detecting seat occupancy allow the occupancy of seats in a motor vehicle to be monitored. A plurality of different systems for seat occupancy detection is currently known, but will not be described here in further detail. In these currently known systems for seat occupancy detection, a seating position deviating from the normal seating position of a person can lead very easily to misdiagnoses. For example, it is difficult for known systems to discern whether a seat is occupied by an adult who has assumed an untypical seating position or by a small child. A clear classification of the person occupying a seat can hitherto not be realized with certainty.

A new and hitherto unpublished system developed by the applicant for detecting seat occupancy is the HOBBIT system (HOBBIT=human observation by beam interference technology). The HOBBIT system comprises a central base station and individual reflectors in the seat for detecting corresponding seat occupancy. In the HOBBIT system, deflection, attenuation and reflection of high frequency signals (for example, 2.45 GHz waves) are beneficially applied to detect the occupancy of the seat by persons. In the HOBBIT system, an area of all seats within a passenger compartment of a motor vehicle to be monitored is illuminated with the high frequency wave field. For this purpose the base station emits frequency-modulated signals with a frequency of 2.45 GHz, which hit the reflector. There they are reflected modulated and received by the base station.

The reflector responses thus obtained are evaluated in respect of their levels. A so-called attenuation thickness is calculated for this purpose. The attenuation thickness denotes the logarithm of the ratio between the emitted and received level of the respective emitted and received signals. The lower the level of the reflected signal received by the base station, the greater the value of the attenuation thickness. The attenuation thickness is thus a measure of seat occupancy, so that a conclusion can be drawn about the occupancy of the seat by a person or an object from the attenuation thickness.

Such a system for seat occupancy detection, which is based on the above-described physical principle, is hitherto not known.

A system for monitoring the occupancy of several seats in a motor vehicle that is equipped with only one HF transmitter is described in the hitherto unpublished patent application of the applicant with the file reference DE 103 12 740.

In the equally hitherto unpublished patent application of the applicant with the file reference DE 103 41 578 it is suggested to determine the occupancy of a seat by HF signals and also to detect whether the safety belt of the occupied seat is attached, with the aid of a belt sensor.

Starting from this, the object of the present invention is now to provide an improved evaluation of the reflector responses in a system for seat occupancy detection.

According to the invention, this object is achieved by an evaluation method with the features of claim 1 and by an evaluation device with the features of claim 9.

The basis of the present invention is the knowledge that different seat occupancies produce different, particularly characteristic reflector responses. By means of special methods according to the invention, with which the individual reflector responses or the levels received at the base station of a system for seat occupancy detection are evaluated, a reliable classification of a person on a seat is possible.

A particular advantage lies in that the approach according to the invention is also applicable to already existing systems for seat occupancy detection.

According to the inventive approach a pre-evaluation of individual reflector response is carried out. The pre-evaluation can be matched specially to the individual areas from which the detected reflector responses originate. After pre-evaluation a classification of the pre-evaluated reflector responses is carried out in order to determine the evaluation result. Pre-evaluation is particularly advantageous in that information from individual reflector responses can be used in a targeted manner in order to obtain additional occupancy information.

Advantageous embodiments and developments of the invention may be inferred from the subclaims and the description with reference to the drawings.

In order to couple the method according to the invention with, for example, an airbag controller, the classification stage can comprise the provision of an enabling signal dependent on the evaluation result. The enabling signal can be an airbag release signal that enables an airbag, when it is detected that a person is located on the seat.

According to a first embodiment of the inventive method, in method step (b), the first decision value, dependent on a comparison of the first reflector response with a predetermined first reference value of the first area, is set to a first value, and the second decision value, dependent on a comparison of the second reflector response with a predetermined first reference value of the second area, is set to the first value. In method step (c), a number of decision values that have the first value are compared with a first number determined by the threshold value rule. According to this embodiment the reference values of the first and second areas can differ from one another. This already allows a weighting of the reflector responses of individual seating areas. Alternatively, the reference values of the first and second areas are identical. The decision values of the areas are set depending on whether the reflector responses exceed or fall short of the associated reference value. The threshold value rule requires a certain first number of decision values that are set according to the comparisons. In this way it is ensured that the evaluation result is not distorted on the basis of single extreme measurement values.

In order to allow an even more precise evaluation of the reflector responses of the individual seating areas, an additional second reference value can be specified for the individual seating areas. According to this embodiment it can be provided that in method step (b), the first decision value, dependent on a comparison of the first reflector response with a predetermined second reference value of the first area, is set to a second value, and the second decision value, dependent on a comparison of the second reflector response with a predetermined second reference value of the second area, is set to the second value. Subsequently in method step (c), a number of decision values that exhibit the second value are compared with a second number determined by the threshold value rule. The advantage of this embodiment lies in that the reflector responses that miss the first reference value can nevertheless still be included in the evaluation result if they comply with the second reference value.

According to a further embodiment, provision can be made that in method step (b) the first decision value is set to a value of the first reflector response weighted with a predetermined weighting factor of the first area, and the second decision value is set to a value of the second reflector response weighted with a predetermined weighting factor of the second area. Subsequently in method step (c) a sum of the decision values is compared with a cumulative value determined by the threshold value rule. Such a method is advantageous in that individual reflector responses can be specially weighted. Thus, for example, reflector responses originating from the center of the seat contribute more strongly to the evaluation result than reflector responses originating from the edge of the seat.

According to a further embodiment, in method step (a) a third reflector response of a third area of the seat is further detected. In method step (b) the first decision value, dependent on a comparison of the first reflector response with a predetermined first reference value of the first area, is set to a first value, and the second decision value, dependent on a comparison of a cumulative second and third reflector response with a predetermined group reference value of the cumulative second and third area, is set to a second value. Finally in method step (c), the second decision value is compared with a group value determined by the threshold value rule and a warning signal is provided dependent on the first decision value. This embodiment allows a special spatial characteristic of the reflector responses to be detected. Such a special characteristic is produced for example by a person sitting on an edge of the seat. In this case only the reflectors in the edge area are covered. A group evaluation of the reflector responses in this area allows such a special sitting position to be detected. An additional safety feature is achieved in that the other reflector responses are also evaluated. If these indicate a special sitting position, for example because they are not covered, a risk to the person can be indicated through the warning signal.

Advantageously, individual embodiments of the evaluation method can be combined with one another. Such a combined evaluation method can comprise the following method steps for example:
(A) determining a first evaluation result and a second evaluation result according to different embodiments of the evaluation method according to the invention;
(B) weighting the first evaluation result with a first classification factor and the second evaluation result with a second classification factor;
(C) providing a correlated evaluation result dependent on the weighted evaluation results.

A combination of different evaluation methods is advantageous in that in this way an even more reliable classification of the seat occupancy is made possible.

If, in spite of a combination of several evaluation methods, no clear classification is possible, this can be indicated by way of a correlated warning signal. The correlated warning signal can also be indicated even when a clear classification is possible, it is, however, determined that a person is located in a dangerous seating position for example. Additional information can be indicated by way of the warning signal, which information is obtained by a correlation of the evaluation results of different evaluation methods.

According to a preferred embodiment of the present invention the predetermined seating areas comprise reflectors that reflect a high frequency signal. In this way, the reflector responses correspond to a signal level of the reflected signal.

Advantageous embodiments and developments of the invention may be inferred from the subclaims and the description with reference to the diagrams.

The invention is described in more detail below, with reference to the exemplary embodiments specified in the schematic figures of the drawings, in which:

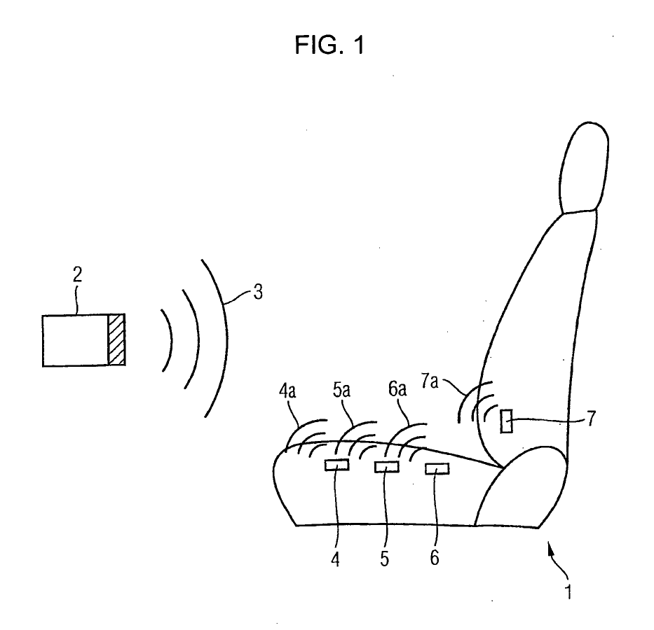

FIG. 1 shows a schematic representation of a system for detecting seat occupancy detection;

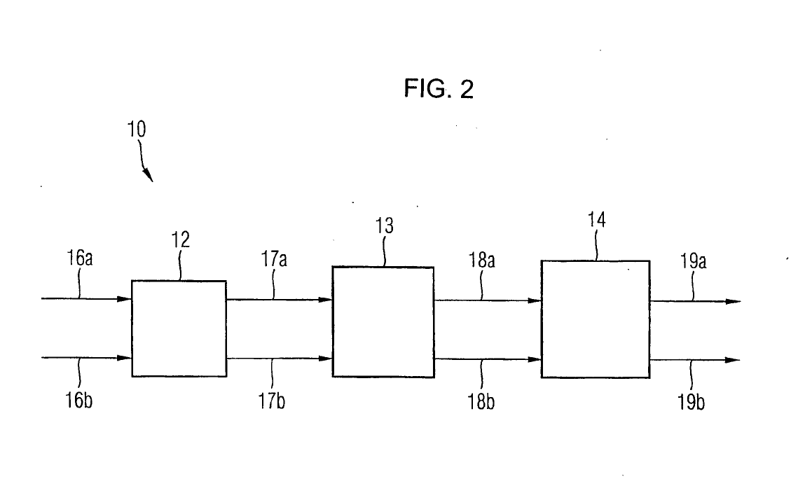

FIG. 2 shows a block diagram of an evaluation device in accordance with the present invention;

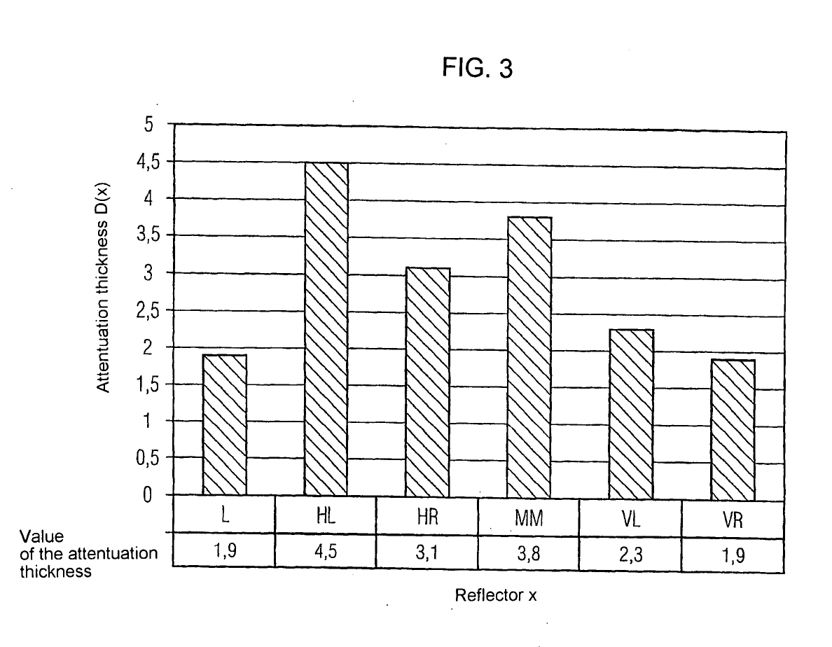

FIG. 3 shows reflector responses of a first exemplary seat occupancy;

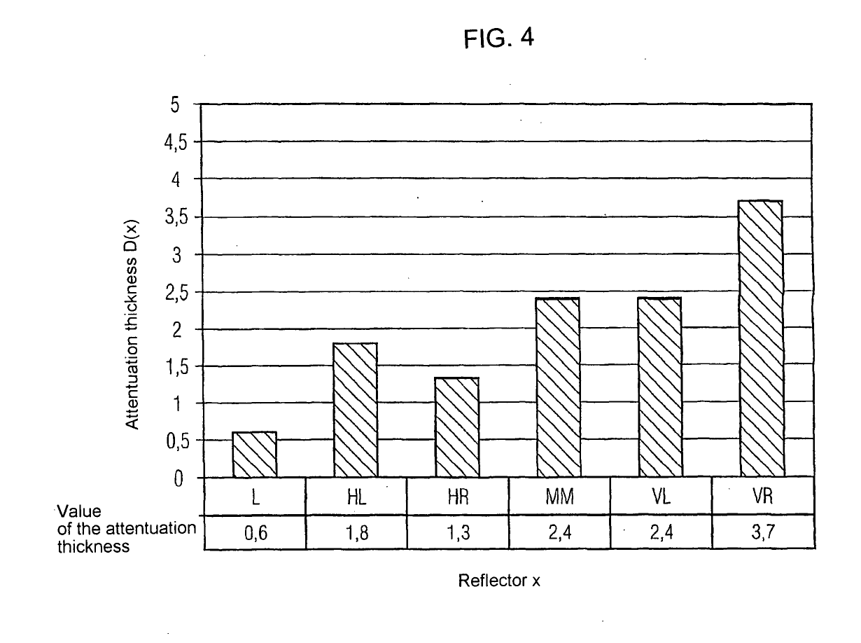

FIG. 4 shows reflector responses of a second exemplary seat occupancy.

In the figures of the drawings, identical or functionally identical components and signals have been given the same reference numbers unless otherwise stated.

FIG. 1 shows a schematic representation of a system for seat occupancy detection using high frequency signals. A seat 1 is illuminated with a high frequency wave field 3 by a HF transmitter in a base station 2. Seat 1 has several reflectors 4, 5, 6, 7 in different positions, said reflectors reflecting the HF wave field 3. Reflectors 4, 5, 6, 7 can return modulated reflected HF wave fields 4a, 5a, 6a, 7a. Reflected HF wave fields 4a, 5a, 6a, 7a are received by a HF receiver in the base station 2. This enables the reflected HF wave fields 4a, 5a, 6a, 7a to be assigned to the individual reflectors 4, 5, 6, 7.

FIG. 2 shows a block diagram of a merely schematically represented evaluation device 10 according to an exemplary embodiment of the present invention. The evaluation device 10 serves to evaluate a number of reflection responses of a system for seat occupancy detection as illustrated, in FIG. 1 for example. In this case the evaluation device 10 can be integrated into the base station 2 shown in FIG. 1, or alternatively can be connected with it as an externally developed device. The evaluation device 10 according to the invention can also be advantageously arranged as a component of an airbag controller (not illustrated).

The evaluation device 10 has a detection unit 12, a determination unit 13 and a classification unit 14.

The detection unit 12 is developed in such a way so as to detect a first reflector response 16a of a first area of a seat and a second reflector response 16b of a second area of the seat. The reflector responses 16a and 16b detected by the detection unit 12 are relayed to the determination unit 13 as detected reflector responses 17a, 17b.

The determination unit 13 serves to determine a first decision value 18a from the first detected reflector response 17a and a second decision value 18b from the second detected reflector response 17b. The decision values 18a, 18b are determined according to predetermined determination rules. The determination rules can be attuned to the individual areas of the seat from which the reflector responses originate. The decision values 18a, 18b determined by the detection unit 12 are relayed to the classification unit 14.

The classification unit 14 determines an evaluation result from the decision values 18a, 18b. For this purpose the classification unit 14 classifies decision values 18a, 18b according to a threshold value rule and correspondingly provides the classification of the evaluation result. According to the embodiment example shown in FIG. 2 an enabling signal in the form of an airbag release signal 19a and a warning signal 19b are relayed depending on the evaluation result. The evaluation result represents a classification of a person sitting on the seat for example, in the categories of a one-year-old child in a child's seat, a lightweight adult, a medium weight adult, etc. This classification is determined by the evaluation device 10 by means of special methods. These methods are translated as determination rules in the determination unit 13 and as threshold value rules in the classification unit 14.

The reflector responses 16a, 16b, which correspond to the levels of the reflected HF radiation received at the base station of the system for seat occupancy detection, serve as the basis of the classification.

For example, the first reflector response 16a can be the reflected HF wave field 4a shown in FIG. 1, and the second reflector response 16b can be the reflected HF wave field 5a. The detected reflector responses 17a, 17b can represent attenuation thicknesses that were determined from the HF wave fields 4a, 5a. Alternatively, the reflector responses 16a, 16b can already be attenuation thicknesses that were determined from the HF wave fields 4a, 5a and relayed from the base station to the detection unit 12. The detected reflector responses 17a, 17b can in this case correspond to the reflector responses 16a, 16b. The airbag release signal 19a and the warning signal 19b can be used to control and/or release an airbag (not shown in the figures). Alternatively, the evaluation result can also be output directly or processed further. Alternatively, only a single evaluation signal or a number of evaluation signals (not shown in the figures) can be provided, which, for example, are processed further in respective safety systems in a motor vehicle, for example, a restraint system (airbag, safety belt, etc.).

Depending on the situation, different methods may be realized for evaluation of the reflector responses 16a, 16b in the evaluation device 10. The different methods are characterized by different determination rules as well as different threshold value rules. In the following exemplary embodiments, reference is made to the system for seat occupancy detection described in FIG. 1. The reflector responses correspond here to the attenuation thicknesses described on the basis of FIG. 1.

In the following, an exemplary embodiment of an evaluation method with threshold value evaluation is described. In the method the evaluation result is determined by means of threshold value evaluation of the attenuation thicknesses of the individual reflectors. The method is described with the example of a small adult sitting in the normal position on the passenger seat. The passenger seat is monitored by the system for seat occupancy detection.

FIG. 3 shows attenuation thicknesses of different reflectors of the passenger seat on which the small adult sits in a normal position.

The individual reflectors L, HL, HR, MM, VL, VR of a seat are plotted on the horizontal axis. With reference to FIG. 1, reflector L can correspond to reflector 7 arranged in the backrest, the reflectors identified with HL and HR correspond to reflector 6 arranged in the rear area of the seat surface, the reflectors identified with ML and MR correspond to reflector 5 arranged in the middle area of the seat surface and the reflectors identified with VL and VR correspond to reflector 4 arranged in the front area of the seat surface.

In addition, the respective values for the attenuation thickness D(x) are shown below the identifier for the corresponding reflectors on the horizontal axis, whereby x=[L, HL, HR, MM, VL, VR] identifies the different reflectors. For the afore-described case of a small adult in a normal position, the reflector L has an attenuation value D(L)=1.9, the reflector HL an attenuation value D (HL)=4.5, the reflector HR an attenuation value D(HR)=3.1, the reflector MM an attenuation value D(MM)=3.8, the reflector VL an attenuation value D(VL)=2.3 and the reflector VR an attenuation value D(VR)=1.9.

The attenuation thicknesses of the individual reflectors L, HL, HR, MM, VL, VR detected by the inventive system for seat occupancy detection are plotted on the vertical axis.

According to the method of the invention, an attenuation thickness D(x)>2.5 for at least two of the reflectors L, HL, HR, MM, VL, VR and an attenuation thickness D(x)>2.0 for at least one further reflector L, HL, HR, MM, VL, VR leads to the airbag being released.

In this case, the determination rules for all areas of the seat are identical. The determination rules comprise a comparison of the individual reflector responses with a predetermined first reference value of 2.5 and a predetermined second reference value of 2.0. Dependent on a comparison result the decision values assigned to the individual reflectors are set. The decision values can have flags that are set or comprise the reference value attained. The decision values are then evaluated according to the threshold value rule. According to the inventive method, the threshold value rule evaluates the number of decision values that show reference values that exceed 2.5 and 2.0 respectively. The airbag enabling signal is then actuated when at least two of the decision values show reference values that exceed 2.5 and at least one further decision value that exceeds reference value 2.0.

For the attenuation thickness shown in FIG. 3, the evaluation method results in the release of the airbag, as the described threshold value rule is fulfilled.

The described reference values, attenuation thicknesses and the number of decision values that exceed the reference values defined by the threshold value rule are chosen by way of example and can be varied. In particular, different reference values can be selected for different areas of the seat. Achieving or not achieving a threshold value can also be evaluated instead of the overshooting of a threshold value.

A further exemplary embodiment of an evaluation method according to the invention, wherein evaluation is carried out by a cumulative attenuation thickness rule, is described in the following. Cumulative attenuation thickness is understood to mean the sum of all attenuation thicknesses. According to this inventive method, a weighted cumulative attenuation thickness SDD is formed from the cumulative attenuation thickness and evaluated according to a threshold value rule corresponding to the method.

Weighted cumulative attenuation thickness SDD is understood to be the sum of the weighted attenuation thicknesses, that is

$$S D D = {\sum }_{i} {y}_{i} * D ( {x}_{1} ) ,$$

where yᵢ denotes an arbitrary weighting coefficient, D(xᵢ) a respective attenuation thickness in each instance and the suffix I, the spacing.

According to this method the determination rules comprise a weighting of the individual reflector responses. The weighting is dependent therein on the area of the seat from which the reflector response originates. The threshold value rule comprises a comparison of the summated weighted reflector responses with a predetermined cumulative value. For example, the airbag is released at a cumulative value of more than 12. The cumulative value corresponds to a weighted cumulative attenuation thickness SDD. In the case of the exemplary embodiment of FIGS. 1 and 2 the weighted cumulative attenuation thickness SDD is derived as follows:
SDD=a*D(L)+b*D(HL)+c*D(HR)+d*D(MM)+e*D(VL)+f*D(VR),
where a, b, c, d, e, f are different weighting factors y for the individual areas from which the individual reflector responses (or attenuation thicknesses) D(L), D(HL), D(HR), D(MM), D(VL), D(VR) originate.

If these attenuation thicknesses D(L), D(HL), D(HR), D(MM), D(VL), D(VR) of the reflectors L, HL, HR, MM, VL, VR are weighted each time with the factor y=1, that is
a=b=c=d=e=f=1,
with the values of the attenuation thicknesses D(x) from FIG. 3 a weighted cumulative attenuation thickness SDD arises as follows:
SDD=1*1.9+1*4.5+1*3.1+1*3.8+1*2.3+1*1.9=17.5
The weighted cumulative attenuation thickness SDD=17.5 is thus greater than the cumulative value given by the threshold value rule of 12. Thus the cumulative attenuation thickness rule is fulfilled and the result is that the airbag is released.

A further exemplary embodiment of an evaluation method by correlation of the individual attenuation thicknesses is described in the following. According to the inventive method, the attenuation thicknesses of individual reflectors, the attenuation thicknesses of reflector pairs or other groups of reflectors are correlated with one another. When certain correlation values are exceeded the airbag is released. The method according to the invention is described for a borderline case in which a small adult sits on the front edge of the passenger seat.

FIG. 4 shows attenuation thicknesses of the reflectors L, HL, HR, MM, VL, VR previously described in FIG. 3 for the case in which a small adult is sitting on the front edge of the passenger seat. In this case the reflector L has an attenuation value of D(L)=0.6, the reflector HL an attenuation value of D(HL)=1.8, the reflector HR an attenuation value D(HR)=1.3, the reflector MM an attenuation value (D(MM)=2.4, the reflector VL an attenuation value D(VL)=2.4 and the reflector an attenuation value D(VR)=3.7.

According to this exemplary embodiment, the two front reflectors VL, VR form a correlation pair, the attenuation thicknesses of which D(VL), D(VR) are correlated with one another and are compared with a predetermined reference value in accordance with a determination rule for the cumulative front area of the seat. For example, the reference value for the front area of the seat can be 6. If the sum of the attenuation thicknesses d(VL), D(VR) of the reflectors VL, VR is greater than 6, according to a corresponding threshold value rule the airbag release signal is set. In addition, a possible threshold value rule can signify that a warning signal is activated in addition to the airbag release signal when none of the remaining attenuation thicknesses is D(x)>2.5. For this purpose the remaining reflector responses are compared with the value 2.5 in accordance with corresponding determination rules in order to obtain the corresponding decision values for the remaining reflector responses.

According to the attenuation thicknesses D(x) shown in FIG. 4 the airbag release signal is set since for the sum of the attenuation thicknesses D(VL), D(VR) of reflectors VL, VR,
D(VL)+D(VR)>6
applies.

In addition, the warning signal is set because no attenuation thickness D(x) of the remaining reflectors L, HL, HR, MM is greater than 2.5. According to the method, on the basis of the evaluation result it is recognized that the person is sitting forward, that is on the front edge of the seat, since both front reflectors VL, VR are covered. As a result, the airbag is released. Since, however, the person has a dangerous position in respect of suffering an injury by the airbag, a warning signal is provided. A warning light on the dashboard, for example, can be triggered by the warning signal. In this case the warning light shows a dangerous situation since in spite of the dangerous seating position, release of the airbag is required.

According to a further exemplary embodiment the evaluation results from previously described evaluation methods are correlated with one another, either weighted or unweighted. If a defined correlation value is exceeded the airbag is released. If no clear indication can be determined as to whether the airbag is to be released, a correlated warning signal is provided, by way of which a warning light on the dashboard is switched on or instance.

The method of correlation of the evaluation results from different evaluation methods is described by means of the attenuation thicknesses shown in FIG. 4.

In accordance with the previously described method with threshold value evaluation, the airbag is not released since only one attenuation thickness, namely the attenuation thickness D(VR) of the reflector VR, is greater than the defined, first predetermined reference value of 2.5. According to the previously described method with a cumulative attenuation thickness rule, with a continuous weighting with the factor 1, the airbag is released, since the weighted cumulative attenuation thickness SDD is >12.

As previously described on the basis of FIG. 4, according to the method by means of correlation the airbag is released and the warning signal is additionally set.

If the evaluation results of the individual method are correlated, the airbag is released according to a correlated evaluation result. Additional information detailing that a dangerous position has been assumed is provided since the backrest is free.

According to the exemplary embodiment, a correlated airbag release signal can then be set when at least one evaluation result or alternatively several evaluation results specify a release of the airbag. In addition or alternatively the individual evaluation results can be weighted with different weighting factors in order for individual evaluation methods to assume a greater contribution in the correlation of the individual evaluation results.

Even if in the preceding exemplary embodiment, reference is made to special embodiments of the components and signals, it is clear to the person skilled in the art that the approach according to the invention can be used for any type of system for detecting seat occupancy that provides differentiable reflector responses for individual seating areas. The reflector responses are not limited to HF signals, but low frequency signals can also be used here. The values mentioned in the exemplary embodiment are selected by way of example and can be replaced by other suitable values. The exemplary embodiments can be arbitrarily combined with one another. Likewise, it can be advantageous to suitably extend the exemplary embodiment according to the inventive approach. This also means, in particular, that further determination rules, threshold value rules and correlation rules can be introduced.

The evaluation device can be realized as a discrete component, for example as ASIC, processor or microcontroller, and also incorporated into an existing system for detecting seat occupancy, or integrated into other control units of the vehicle, for example airbag controller. The method described can be realized for example as a VHDL code and used for programming a chip.

In particular, the schematic construction of a seat in FIG. 1 as well as the arrangement of the sensors are also only to be understood as exemplary. It is understood that more or less or even no sensors can be provided in the area of the seat surface. The same also applies to the backrest.

An example with only two channels for the reflection responses is also described in FIG. 2. It is also understood here that more than two channels can be provided.

1-10. (canceled)

11. An evaluation method for evaluating a plurality of reflector responses of a system for seat occupancy detection, wherein the method comprises the following steps:
(a) detecting a reflected first reflector response, in response to an emitted high frequency signal, of a first area of a seat and a second reflector response of a second area of a seat;
(b) determining a first decision value from the first reflector response in accordance with a determination rule assigned to the first area and determining a second decision value from a second reflector response in accordance with a determination rule assigned to the second area; and
(c) classifying the determined decision values according to a threshold value rule for the determination of an evaluation result.

12. The method according to claim 11, which comprises evaluating a seat occupancy in a motor vehicle.

13. The method according to claim 11, wherein method step (c) comprises providing a release signal in dependence on the evaluation result.

14. The method according to claim 11, wherein:
method step (b) comprises setting the first decision value, in dependence on a comparison of the first reflector response with a predetermined first reference value of the first area, to a first value, and setting the second decision value, in dependence on a comparison of the second reflector response with a predetermined first reference value of the second area, to the first value; and
method step (c) comprises comparing a number of decision values including the first value with a first number determined by way of the threshold value rule.

15. The method according to claim 14, wherein:
method step (b) comprises setting the first decision value, in dependence on a comparison of the first reflector response with a predetermined second reference value of the first area, to a second value and setting the second decision value, in dependence on a comparison of the second reflector response with a predetermined second reference value of the second area, to the second value; and
method step (c) comprises comparing a number of decision values including the second value with a second number determined by the threshold value rule.

16. The method according to claim 11, wherein:
method step (b) comprises setting the first decision value to a value of the first reflector response weighted with a predetermined weighting factor of the first area and setting the second decision value to a value of the second reflector response weighted with a predetermined weighting factor of the second area; and
method step (c) comprises comparing a sum of the decision values with a cumulative value determined by the threshold value rule.

17. The method according to claim 11, wherein:
method step (a) further comprises detecting a third reflector response of a third area of the seat;
method step (b) comprises setting the first decision value, in dependence on a comparison of the first reflector response with a predetermined first reference value of the first area, to a first value and setting the second decision value, in dependence on a comparison of a cumulative second and third reflector response with a predetermined group reference value of the cumulative second and third areas, to a second value; and
method step (c) comprises comparing the second decision value with a group value determined by the threshold value rule and issuing a warning signal in dependence on the first decision value.

18. The method for evaluating a plurality of reflector responses of a system for seat occupancy detection, the method which comprises the following method steps:
(A) determining a first evaluation result with a method according to claim 14, with a method according to claim 16, or with a method according to claim 17, and determining a second evaluation result with another method according to claim 14, according to claim 16, or according to claim 17;
(B) weighting the first evaluation result with a first classification factor to form a first weighted evaluation result and weighting the second evaluation result with a second classification factor to form a second weighted evaluation result; and
(C) providing a correlated evaluation result in dependence on the first and second weighted evaluation results.

19. The method according to claim 18, wherein method step (C) further comprises providing a correlated release signal, in dependence on the correlated evaluation result, and providing a correlated warning signal when a comparison of the first and second weighted evaluation results with a predetermined evaluation value provides no clear correlated evaluation result.

20. An evaluation device for evaluating reflector responses in a system for seat occupancy detection, comprising:
a detection unit for detecting a first reflector response of a first predetermined area of a seat reflected in response to an emitted high frequency signal, and for detecting a second reflector response of a second predetermined area of the seat;
a determination unit connected to said detection unit and configured to determine a first decision value from the first reflector response in accordance with a determination rule assigned to the first area and for determining a second decision value from the second reflector response according to a determination rule assigned to the second area; and
a classification device connected to said determination unit for classifying the decision values according to a threshold value rule and for determining an evaluation result derived therefrom.

21. The evaluation device according to claim 20, wherein reflectors are disposed at the predetermined areas of the seat, said reflectors reflecting an emitted high frequency signal and the reflector responses corresponding to a signal level of a reflected signal.

22. The evaluation device according to claim 20, configured for carrying out the method according to claim 11.
